(19) United States
(12) Patent Application Publication
(10) Pub. No.: US 2026/0208642 A1
(43) Pub. Date: Jul. 23, 2026

(54) SYSTEM OF SEAT ELEMENTS, SET OF SEAT ELEMENTS, METHOD FOR MANUFACTURING A SEAT ELEMENT AS WELL AS VEHICLE SEAT

(71) Applicant: Faurecia Autositze GmbH, Hannover (DE)

(72) Inventors: Carsten REITH, Niedernwöhren (DE); Abhijeet PHARATE, Old Sangvi (IN)

(73) Assignee: Faurecia Autositze GmbH, Hannover (DE)

(21) Appl. No.: 19/452,838

(22) Filed: Jan. 19, 2026

(30) Foreign Application Priority Data
Jan. 21, 2025 (DE) 10 2025 102 047.7

(51) Int. Cl. B60N 2/68

(52) U.S. Cl. CPC B60N 2/682; B60N 2205/30; B60Y 2304/07

(57) ABSTRACT

A system including structural frames differing in a position of a front cross tube, a seat shell with a fastening member comprising two fastening channels extending in the perpendicular direction, where each structural frame is associated with one of the fastening channels, where the fastening channels are positioned on the fastening member and have a cross-section such that the front cross tubes of the different structural frame can be received in the respectively associated fastening channel when the seat shell is assembled on the structural frame, and a locking part which can attach to the seat shell via fastener means and which is shaped such that a fastening compartment is formed by one of the fastening channels on the seat shell and the locking part when the locking part is attached to the seat shell in which the front cross tube of the associated structural frame can be received.

This application claims priority of Germany Application No. DE 10 2025 102 047.7, filed January 21, 2025, which is hereby incorporated herein by reference in its entirety.

The invention relates to a system of seat elements consisting of a structural frame and seat shells which are suitably assembled in a modular manner, a set of seat elements consisting of various seat elements, a method for manufacturing a seat element from the system of seat elements, as well as a vehicle seat.

Vehicle seats typically comprise a seat element auf which consists of a das seat shell and a structural frame, where the seat shell is affixed, in particular, to a front cross tube of the structural frame via at least one locking part. Hereby, the locking part together with a fastening member on the seat shell forms one single fastening compartment in which the front cross tube of the selected structural frame can be mounted. By way of example, seat elements of this type have been described in the documents EP 1 373015 A1 and DE 10 2007 058 331 B4.

Hereby, depending on the design of the seat element, the front cross tubes of the structural frame may be arranged at different positions. Thus, different structural frames require different seat shells because every seat shell usually comprises only one fastening member adapted to the design of the respective structural frame in which a structural frame having a differently positioned front cross tube can then no longer be mounted. This increases complexity of manufacturing, in particular, the number of seat shells to be manufactured and stored as well as the complexity of commissioning.

It is the object of the invention to provide a system of seat elements allowing for manufacturing a seat element in modular fashion with little manufacturing complexity. A further object is to provide a set of seat elements, a method for manufacturing a seat element as well as a vehicle seat.

This task is solved by a system of seat elements, a set of seat elements, a method for manufacturing a seat element as well as a vehicle seat according to the independent claims. The sub-claims describe preferred further developments.

Thus, invention provides for a system of seat elements for manufacturing a seat element of a vehicle seat in modular fashion, comprising at least:

A number of at least two different structural frames, preferably made of a metal material, differing at least in one position (position in the longitudinal direction and/or in the vertical direction of the structural frame) of a front cross tube (extension in the perpendicular direction of the structural frame) on the respective structural frame. Hereby, the cross tubes are fixes, as usual, between lateral frame parts of the respective structural frame.

Furthermore, at least one seat shell, preferably made of plastics, including at least one fastening member comprising at least two fastening channels extending in the perpendicular direction, each one of the fastening channels being associated with each one of the at least two different structural frames, preferably a different fastening channel to each variant of the structural frame. Hereby, the term fastening channel shall mean a region introduced into the fastening member that contributes to holding the front cross tube of the associated structural frame securely on the seat shell, in particular, in connection with a locking part to be described below. To that end, the fastening channels are positioned on the fastening member of the seat shell and have a cross-section such that the front cross tubes of the at least two different structural frames can be received, at least in part, in or by the respectively associated fastening channel on the seat shell when the seat shell is or is being mounted on the respective structural frame.

Furthermore, at least one locking part which can be affixed to the seat shell via at least one fastener means, the locking part being shaped such that a fastening compartment is formed on the seat shell by of one of the fastening channels and the respective locking part when the respective locking member is affixed, and the front cross tube of the respectively associated structural frame can be received, preferably fully received, in said fastening compartment. Thus, the front cross tube is then held form-fit inside the fastening compartment. Hereby, the locking part secures the fit of the respective front cross tubes on or in the respectively associated fastening channel on the seat shell, where, depending on the design, the front cross tube je can still rotate about its longitudinal axis inside the fastening compartment. Thus, a fastening compartment is formed in which the front cross tube of the respectively associated structural frame can be received, for example, with play, in particular, with a clearance fit or a transition tolerance.

Such a system of seat elements allows for a modular design of a seat element to be attained because, depending on the prior selected or determined variant of the structural frames, the same seat shell can be utilized so as to reduce manufacturing complexity. Thus, merely one type of seat shell needs to be manufactured, stored and retrieved from storage, and this can then be affixed to the different structural frames. Hereby, the structural frames differ, for example, in their application on an adjustable seat element or on a non-adjustable or, respectively, fixed seat element.

Preferably, it is further provided that at least two different locking parts are provided, with each of the at least two different structural frames being associated with a different locking part. Thus, the locking parts may be purposefully adapted to the different variant of the structural frame and, therewith, also to the respective position of the fastening channels on the seat shell so as to form a fastening compartment matched to the variant and securely and permanently holding the front cross tube in this fastening compartment. Thus, different locking parts must then be provided, stored and correspondingly selected for assembly. In the event of only one universal connector element, however, the manufacturing complexity is simplified accordingly.

Preferably, it is further provided that every locking part comprises at least one channel-shaped recess, where the at least one channel-shaped recess is positioned on the respective locking part and has such a cross-section that the respective fastening compartment is formed by one of the fastening channels on the seat shell and the respective channel-shaped recess on the respective locking part, when the respective locking part is affixed to the seat shell, in that upon assembly the front cross tube of the respectively associated structural frame can be received such that the front cross tube is held permanently on the seat shell, preferably in a form-fit manner.

Thus, in a way similar to the fastening channel on the seat shell, a region is also introduced or formed in the locking part which contributes to securely hold the front cross tube of the associated structural frame on the seat shell. Then, the respective fastening channel on the seat shell and the channel-type recess on the respective locking part complement each other so as to securely allow for a friction-locking mounting of the front cross tubes of the associated structural frame.

To that end, it is preferably provided that the at least one channel-shaped recess and the fastening channels have a round cross-section so as to form a fastening compartment essentially round in cross-section for receiving the front cross tube of the respectively associated structural frame, where the respective front cross tube preferably also has an essentially round cross-section that is adapted to the round cross-section of the fastening compartment for a form-fit reception.

Hereby, the term round cross-section is to be understood such that the channel-shaped recess and the fastening channels follow a rounding, for example, a circle segment or an ellipse segment or similar. The front cross tube is then shaped at its exterior surface in a suitably complementary way, i.e., circular or elliptic or similar in cross-section, so it can be enveloped, at least in part, custom-fit by the channel-shaped recess and the respective fastening channel. In principle, polygonal or other cross-sections of the channel-shaped recess and the fastening channels are also possible which then form a fastening compartment polygonal in cross-section in which, in however, also a front cross tube with a round cross-section can be received. Thus, a variable design of the respective fastening compartments is possible so as to also allow for a flexible adaptation of the respective front cross tubes.

Preferably, it is further provided that each of the number of at least two different structural frames further comprises a rear cross tube, with the rear cross tube of each structural frame being positioned essentially identically, and the respective structural frame being capable of being affixed to the seat shell also via the rear cross tube, with some play, for example, via a U-shaped profile on the seat shell. Thus, a further (rear) connection of the structural frame with the seat shell can be made universally so that a position variation ensues only in the frontal region or, respectively, via the front cross tube, and the fastening channels adapted to the variant must be formed only there.

Preferably, it is further provided that the locking part can be attached to the seat shell via the at least one fastener means by means of a screw connection and/or by means of an anchoring, where, to that end, the locking part comprises an anchoring element, for example, a hook, which can engage with a an undercut groove in the seat shell so as to hold the locking part form-fit on the seat shell; and/or where the locking part comprises hole through which a screw can be inserted to screw this into an internal thread in the seat shell so as to hold the locking part on the seat shell.

Thus, different options of attachment are provided which may be combined with one another in any way so as to permanently form the fastening compartment in a simple manner.

Preferably, it is further provided that two fastening members spaced apart from one another in the perpendicular direction each having at least two fastening channels extending in the perpendicular direction are arranged on the seat shell, where the fastening channels of different fastening members are arranged in alignment on the seat shell, preferably symmetrical to the longitudinal center line of the seat shell, so that the front cross tube of the respective structural frame can be received in the respectively associated fastening channels of the two different fastening members. Thus, the front cross tube is secured at two different positions in the perpendicular direction, preferably in a symmetrical manner, thereby improving the overall stability and hold.

The invention also provides for a set of seat elements, comprising at least:

A first seat element, preferably made from a system of seat elements according to the invention as described above, including at least one first structural frame according to a first variant with a front cross tube at a first position and a seat shell held on the first structural frame via a locking part attached to the seat shell, preferably held in a form-fit manner.

Hereby, the seat shell comprises at least one fastening member comprising at least two fastening channels extending in the perpendicular direction, where the locking part and a first fastening channel of the at least one fastening member associated with the first structural frame form a first fastening compartment in which the front cross tube of the first structural frame is received. Preferably, the front cross tube of the first structural frame can still rotate about its longitudinal axis inside the first fastening compartment, where, to that end, the front cross tube of the first structural frame is received in the first fastening compartment, for example, with some play, in particular, with a clearance fit or a transition tolerance.

Furthermore, a second seat element, preferably made from a system of seat elements according to the invention as described above, including at least one second structural frame according to a second variant with a front cross tube at a second position, different from the first position, and a seat shell held on the second structural frame via a locking part attached to the seat shell, preferably held in a form-fit manner.

Hereby, the seat shell comprises at least one fastening member comprising at least two fastening channels extending in the perpendicular direction, where the locking part and a second fastening channel of the at least one fastening member associated with the second structural frame form a second fastening compartment in which the front cross tube of the second structural frame is received. Preferably, the front cross tube of the second structural frame can still rotate about its longitudinal axis inside the second fastening, where, to that end, the front cross tube of the second structural frame is received in the second fastening compartment, for example, with some play, in particular, with a clearance fit or a transition tolerance.

This yields the aforementioned advantages allowing for manufacturing a set of different seat elements from only one type of seat shells, preferably seat shells of identical design, with differently designed structural frames. These can be mounted in a vehicle depending on specifications.

Preferably, it is further provided that the seat shell of the first seat element is held on the structural frame via a first locking part attached to the seat shell, and the seat shell of the second seat element is held on the structural frame via a second locking part attached to the seat shell, the first locking part and the second locking part differing in design, in particular, both locking parts having different or, respectively differently designed channel-shaped recesses, each forming, together with the associated fastening channel of the fastening member on the seat shell, the respective fastening compartment for receiving the front cross tubes of the respectively associated structural frame. Thus, even different locking parts may be provided for the different seat elements to guarantee a secure hold of the seat shell on the respective structural frame.

The invention further provides for a method for manufacturing a seat element of a vehicle seat, preferably from a system of seat elements according to the invention as described, including at least the following steps:

- selecting or determining a variant of the structural frame and ,therewith, the seat element to be manufactured;- providing --- a seat shell including at least one fastening member having at least two fastening channels extending in the perpendicular direction, --- a structural frame corresponding to the determined variant from a number of at least two structural frames differing at least in a position of a front cross tube on the respective structural frame, as well as -- a locking part;- assembling the provided seat shell on the provided structural frame such that the front cross tube of the provided structural frame is received in a fastening channel, associated with the determined variant of the structural frame, of the at least one fastening member in the provided seat shell;- fixing the front cross tube of the provided structural frame received in the respective fastening channel via the provided locking part in that the provided locking part is attached to the seat shell via at least one fastener means, and the fastening channel on the seat shell associated with the determined variant of the structural frame and the respective locking part form a fastening compartment in which the front cross tube of the provided structural frame is received, preferably received in a form-fit manner; and- finishing the seat element in further steps.

The invention further provides for a vehicle seat including a seat element and a backrest, where the seat element is made from a system of seat elements according to the invention as described, preferably according to the method according to the invention as described.

### BRIEF DESCRIPTION OF DRAWINGS

The invention will be further illustrated in the following by means of the accompanying drawings by means of an embodiment example. It is shown in:

FIG. 1 a vehicle seat including a seat element in a schematic lateral view;

FIG. 2 a detailed view of a seat shell of the vehicle seat according to FIG. 1;

FIG. 3A, 3B detailed views of locking parts of different designs;

FIG. 4A, 4B detailed views of the seat shell according to FIG. 2 with the fitted locking parts from FIGS. 3A and 3B for different variants of structural frames of the seat element;

FIG. 5 a flow chart of a method for manufacturing a seat element of a vehicle seat; and

FIG. 6 an exemplary set of seat elements.

### DETAILED DESCRIPTION

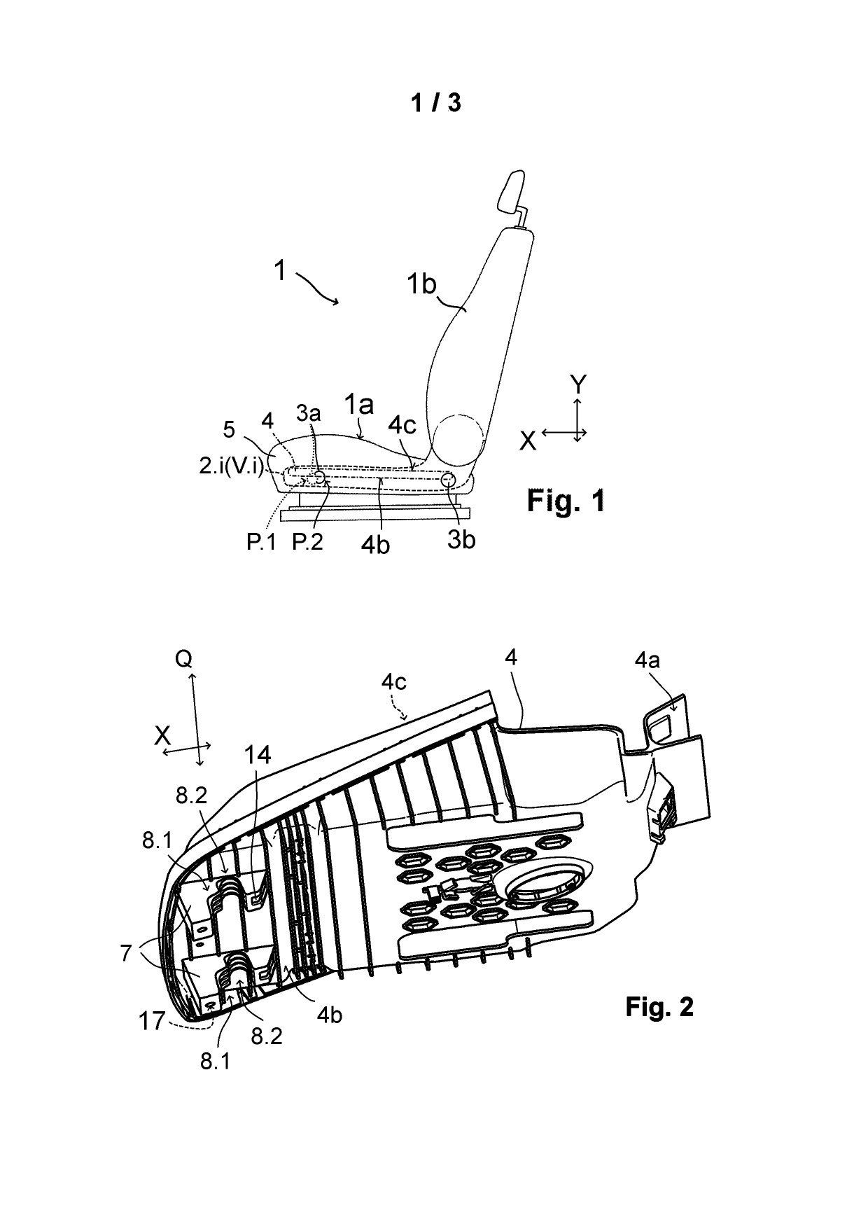

FIG. 1 schematically shows a vehicle seat 1 with a seat element 1a and a backrest element 1b pivoting in relation thereto. The seat element 1a comprises a structural frame 2.i, where i=1,…, N, preferably made of metal, where the structural frame 2.i comprises a front cross tube 3a and a rear cross tube 3b extending in-between lateral frame parts of the structural frame 2.i each in the perpendicular direction Q.

The structural frame 2.i may be selected, depending on the application, from N different variants V.i, where i=1,…, N, where the variants V.i differ, in particular, in a position P.i (position in the longitudinal direction X and/or in the vertical direction Y in relation to the structural frame 2.i) of the front cross tube 3a, as indicated in FIG. 1 by a dotted line. Preferably, there are N=2 different variants V.i, i.e., a first structural frame 2.1 with the front cross tube 3a in a first position P.1 (first variant V.1) and a second structural frame 2.2 with the front cross tube 3a in a second position P.2 (second variant V.2) different from the first position P.2. The first variant V.1 may be provided, for example, for a fixed seat element 1a, and the second variant V.2 for a tilt adjustable seat element 1a. Depending on the design and application of the vehicle seat 1 further variants V.i are possible too.

A seat shell 4 made of plastic is attached to the respective structural frame 2.i, the seat shell 4 holding an upholstery element 5 which is finally, for example, lined by a cover. The seat shell 4 is held on the front cross tube 3a at its rear side, for example, via a U-shaped profile 4a (see FIG. 2), on the rear cross tube 3b and at its front side via a locking arrangement to be further descried in the following. In order to allow one and the same seat shell 4 to be used in a flexible manner for different variants V.i of the structural frame 2.i, a modular design of the fastening between the front cross tube 3a and the seat shell 4 is provided as follows:

As shown in FIG. 2, two fastening members 7 spaced apart in the perpendicular direction Q are formed, preferably shaped into or onto the seat shell 4, on an underside 4b of the seat shell 4 facing downward or, respectively, facing the front cross tube 3a lying opposite an upper side 4c of the seat shell 4 accommodating the upholstery element 5 and facing the seat occupant. Each fastening member 7 comprises at least two fastening channels 8.i; where i= 1, …N, extending in the transverse direction Q and preferably running parallel to one another. Hereby, each variant V.i of the structural frame 2.i is associated with a certain fastening channel 8.i, preferably each variant V.i with a different fastening channel 8.i, i.e., in the case of the two aforementioned variants V.1, V.2, the first structural frame 2.1 with a first fastening channel 8.1, and the second structural frame 2.2 with a second fastening channel 8.2. Thus, this means that the position of the fastening channels 8.i within the respective fastening member 7 is adapted to the position P.i of the front cross tube 3a. In the embodiment shown, the attachment to the rear cross tube 3b via the U-shaped profile 4a remains unchanged in both variants V.i.

The fastening channels 8.i each have a cross-section such that the cross-section of the front cross tube 3a of the respectively associated structural frame 2.i can be accommodated therein, at least in part. As shown, to that end, the fastening channels 8.i each have a rounded cross-section geometry which matches the round cross-section of the front cross tube 3a. However, angular or other cross-section geometries are possible too.

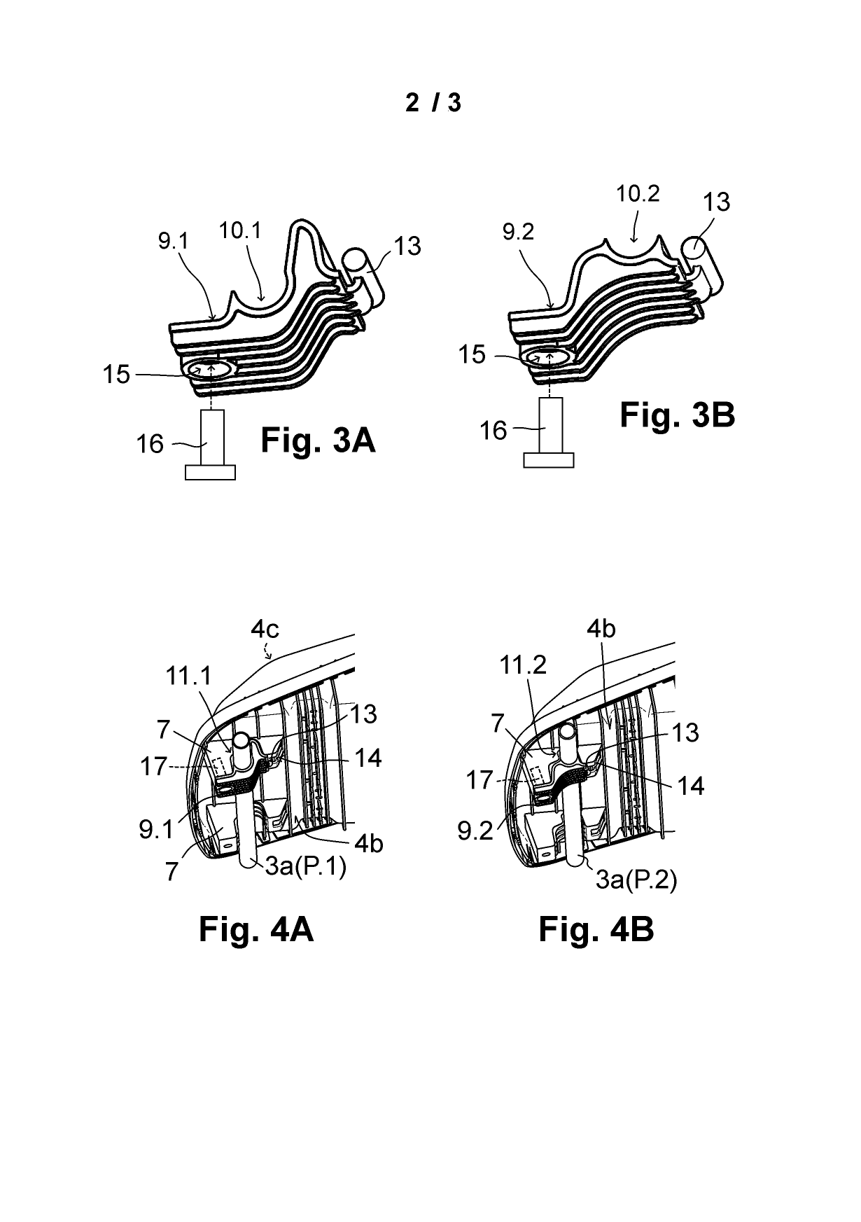

Onto each fastening member 7 a locking part 9.i, where i= 1,…N, can be placed, where, in FIGS. 3A and 3B, two different locking parts 9.1, 9.2 are shown that are used depending on the selection of the variant V.i of the structural frame 2.i. Thus, each variant V.i of the structural frame 2.i is associated with a certain locking part 9.i, preferably each variant V.i with a different locking part 9.i. To that end, each locking part 9.i is provided with a channel-shaped recess 10.i the position of which is adapted to the position P.i of the front cross tube 3a of the respectively selected structural frame 2.i, i.e., the two locking parts 9.1, 9.2 differ, in particular, in that the channel-shaped recesses 10.i are positioned differently thereon.

Moreover, the respective channel-shaped recess 10.i has a cross-section such that the cross-section of the front cross tube 3a of the respectively associated structural frame 2.i can be accommodated therein, at least in part. As shown, to that end, the channel-shaped recess 10.i has a rounded cross-section geometry matching the round cross-section of the front cross tube 3a. However, angular or other cross-section geometries are possible too. The locking parts 9.i may further be provided with a ribbed structure so as to save weight while having an increased stability.

When the locking part 9.i associated with a certain variant V.i is placed on the fastening member 7, then the channel-shaped recess 10.i this locking part 9.i together with the fastening channel 8.i associated with the variant V.i defines a fastening compartment 11.i, where i=1,…,N, as shown in FIGS. 4A and FIG. 4B. This fastening compartment 11.i runs in the transverse direction Q and is positioned and shaped such that the front cross tube 3a of the structural frame 2.i associated with the respective variant V.i can be form-fit received therein to hold it. To that end, the respective locking part 9.i and the respective fastening member 7 envelope the full circumference of the front cross tube 3a received in the respective fastening compartment 11.i soi as to guarantee a secure hold. However, the friction locking connection may already be attained in the event of an only partial surrounding. Moreover, the front cross tube 3a can remain rotatable (about its own axis) in the fastening compartment 11.i.

The respective placed-on locking part 9.i is affixed to the fastening member 7 via suitable fastener means 12 so as to permanently hold the front cross tube 3a. To that end, as shown in the Figures, an anchoring element 13, for example, a hook, may be arranged at one end on the locking part 9.i which can be brought into engagement with an undercut groove 14 (groove having one or more undercuts) or similar so as to hold the one end of the locking part 9.i by means of an anchoring on the fastening member 7 in a form-fit manner. At the other end of the locking part 9.i a hole 15 is introduced through which a screw 16 can be inserted to screw this into an internal thread 17 in the fastening member 7. This way, a screw connection can be generated securing the engagement of the anchoring element 13 with the undercut groove Nut 14. However, other combinations of such types of connections as well as other types of connections using further fastening means 12 are possible also, by means of which the place-on locking part 9.i can be securely affixed to the fastening member 7 so as to permanently hold the front cross tube 3a on the seat shell 4.

Alternatively, only one universal locking part 9.i may be provided for all variants V.i which, in this case, is designed such that it forms, together with the respective fastening channels 8.i, several fastening compartments 11.i at the same time, for example, by means of multiple channel-shaped recesses 10.i on one and the same locking part 9.i. In that case, the front cross tube 3a of the respectively selected structural frame 2.i is form-fit received in only one of the formed fastening compartments 11.i. The respective other fastening compartment 11.i or compartments then remains or remain unoccupied. Therefore, each structural frame 2.i is associated with the same (universal) locking part 9.i, but each structural frame 2.i yet still another fastening channel 8.i on the seat shell 4. In contrast hereto, in the embodiment described above and depicted in the Figures, only one fastening compartment 11.i is formed for the front cross tube 3a of the respectively associated structural frame 2.i so that each structural frame 2.i is associated with another locking part 9.i.

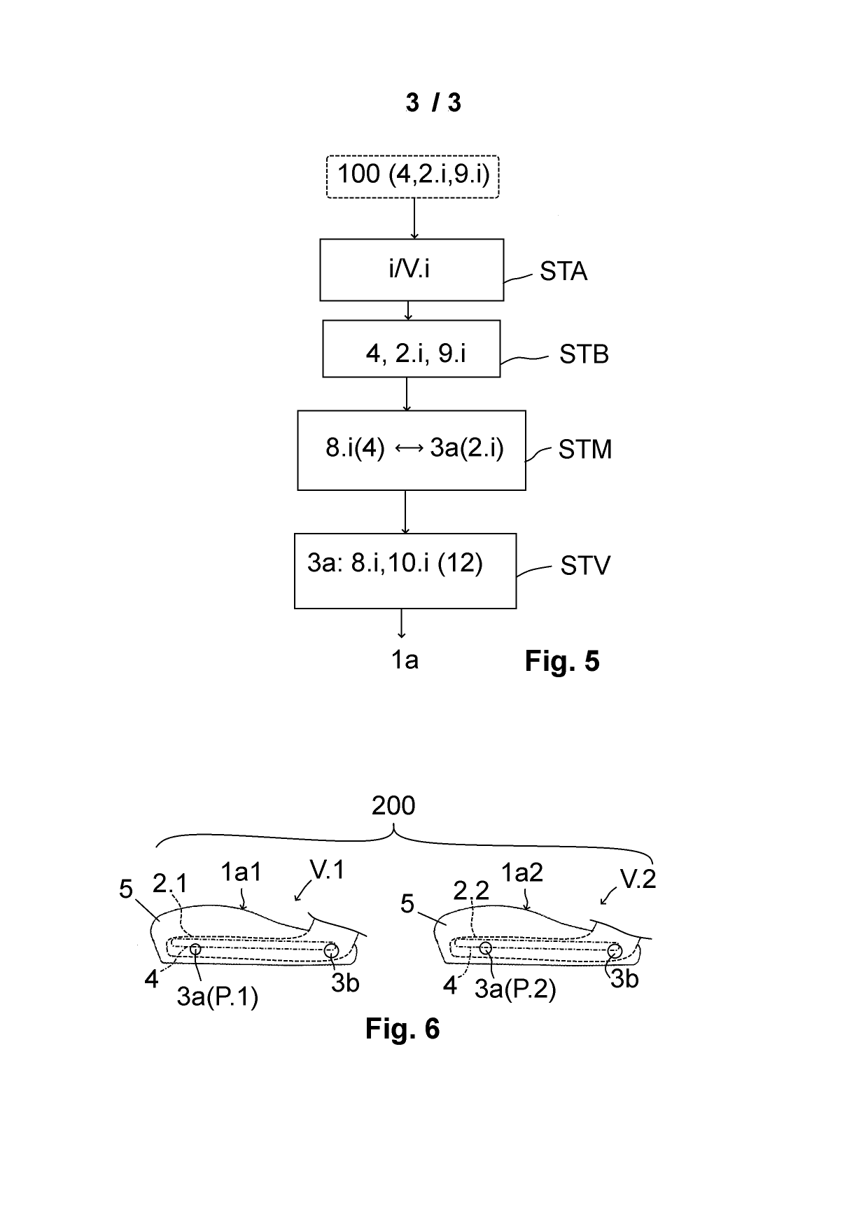

Using the described components a seat element 1a can be manufactured in modular fashion from a seat shell 4 and a selected structural frame 2.i according to the flow chart shown in FIG. 5, for example, as follows. Hereby, the starting point is a system of seat elements 100 composed at least of similar or, respectively, essentially identically designed seat shells 4 as well as a number N of at least two variants V.i; V1, V2 of structural frames 2.i as well as associated locking parts 9.i. Hereby, the system of seat elements 100 is distinguished in that the variants V.i of the structural frame 2.i each differ in design, at least in the position P.i of the front cross tube 3a, so that the system of seat elements 100 can be utilized accordingly to manufacture a number N of different seat elements 1a.

Initially, in a step of selecting STA, the variant V.i of the structural frame 2.i and, therewith, the seat element 1a to be manufactured is selected or determined, for example, depending on the vehicle model and/or on the customer selection and/or similar.

In a step of providing STB or commissioning step, the seat shell 4, the structural frame 2.i corresponding to the selected variant V.i, as well as the locking part 9.i corresponding to the selected variant V.i are provided. Thus, a seat shell 4, for example, from a number of similar seat shells 4, is retrieved from the system of seat elements 100 and made available, and the respective structural frame 2.i and the locking part 9.i corresponding to the variant V.i are retrieved from the system of seat elements 100 and made available.

Subsequently, in a step of assembling STM, the structural frame 2.i and the seat shell 4 are placed on one another or joined such that the front cross tube 3a of the selected structural frame 2.i is received in the provided seat shell 4 in the fastening channel 8.i of the fastening member 7 associated with the variant V.i. Here, the advantage is that the seat shell 4 is identical for all possible variants V.i of the structural frame 2.i from the system of seat elements 100, where it provides one fastening channel 8.i for receiving the respective front cross tubes 3a for every possible variant V.i of the structural frame 2.i, preferably a different fastening channel 8.i for each variant V.i.

The rear cross tube 3b of the selected structural frame 2.i can also be affixed to the seat shell 4 in a suitable manner, i.e., for that purpose, too, a corresponding element is provided on the universal seat shell 4, for example, the U-shaped profile 4a. Aside from the fixation via the front cross tube 3a, however, an additional fixation of the seat shell 4 may happen at the selected structural frame 2.i but also in other ways in a universal manner so as to allow the same seat shell 4 to be used for every variants V.i of the structural frame 2.i.

In a subsequent step of closing STV, the front cross tube 3a of the selected structural frame 2.i received in the respective fastening channel 8.i is permanently fixed via the selected locking part 9.i associated with the variant V.i (if applicable, also the universal locking part 9.i). Hereby, the front cross tube 3a is enveloped by the associated fastening channel 8.i and the channel-shaped recess 10.i in the associated locking part 9.i. and this is secured via the respective fastener means 12, as described, so as to permanently create a secure form-fit connection.

This way, a seat element 1a corresponding to the selected variant V.i can finally be formed in further steps, for example, assembling the upholstery element 5. This can then be combined with a provided backrest part 1b via a suitable mechanism, for example, tilt adjustment mechanism, to form a vehicle seat, as shown in FIG. 1.

Thus, by means of the corresponding system of seat elements 100 different seat elements 1a can be manufacture depending on the selected variant V.i so that the respective manufacturer is capable of offering and providing in a simple manner a modular designed set of seat elements 200, which in the example shown in FIG. 6 consists of two different seat elements 1a1, 1a2. Thus, when a number N of two different structural frames 2.i are offered, then these can be used to manufacture two different seat elements 1a1, 1a2 for different selected variants V.i, e.g., by different customers or for different classes of vehicles, each in accordance with the process described in the flow chart in FIG. 5. For a larger number N of possible variants V.i a correspondingly larger set of seat elements 200 consisting of more than two seat elements 1a may be provided.

### LIST OF REFERENCE NUMERALS

1 vehicle seat

1a seat element

1a1 first seat element

1a2 second seat element

1b backrest part

2.i structural frame

3a front cross tube of the structural frame 2.i

3b rear cross tube of the structural frame 2.i

4 seat shell

4a U-shaped profile on the seat shell 4

4b underside of the seat shell 4

4c upper side of the seat shell 4

5 upholstery element

7 fastening member

8.i i. fastening channel

9.i i. locking part

10.i i. channel-shaped recess

11.i i. fastening compartment

12 fastening means

13 anchoring element

14 undercut groove

15 hole

16 screw

17 internal thread

100 system of seat elements

200 set of seat elements

N number of variants of the structural frame 2.i

P.i position of the front cross tubes 3a

Q transverse direction

STA step of selecting

STB step of providing

STM step of assembling

STV step of closing

V.i i. variant of the structural frame 2.i

X longitudinal direction

Y vertical direction

1. A system of seat elements for modular manufacturing of a seat element of a vehicle seat, comprising at least:
a number of at least two different structural frames, differing at least in a position of a front cross tube on the respective structural frame,
a seat shell including at least one fastening member, comprising at least two fastening channels extending in the perpendicular direction, each of the at least two different structural frames being associated with one of the fastening channels,
where the fastening channels are positioned on the fastening member and have a cross-section such that the front cross tubes of the at least two different structural frames can be received, at least in part, in the respectively associated fastening channel on the seat shell when the seat shell is assembled on the respective structural frame, and
a locking part which can be affixed to the seat shell via at least one fastener means, where the locking part is shaped such that one of the fastening channels on the seat shell and the respective locking part form a fastening compartment when the respective locking part is attached to the seat shell, in which the front cross tube of the respectively associated structural frame can be received such that the front cross tube is permanently held on the seat shell.

2. The system of seat elements according to claim 1, wherein at least two different locking parts are provided, with each of said at least two different structural frames being associated with another locking part.

3. The system of seat elements according to claim 1, wherein each locking part comprises at least one channel-shaped recess, the at least one channel-shaped recess being positioned on the respective locking part and has a cross-section such that one of the fastening channels on the seat shell and the respective channel-shaped recess on the respective locking part form the respective fastening compartment when the respective locking part is attached to the seat shell, in which the respectively associated structural frame of the front cross tube can be received upon assembly.

4. The system of seat elements according to claim 3, wherein the at least one channel-shaped recess and the fastening channels have a round cross-section so as to form a fastening compartment with a round cross-section for receiving the front cross tube of the respectively associated structural frame, where the respective front cross tube preferably has a round cross-section.

5. The system of seat elements according to claim 1, wherein the number of at least two different structural frames each being further provided with a rear cross tube, the rear cross tube of each structural frame being positioned essentially identically, and the respective structural frame being capable of being affixed to the seat shell also via the rear cross tube, preferably with some play, for example, via a U-shaped profile on the seat shell.

6. The system of seat elements according to claim 1, wherein the fastening channels on the fastening member have a cross-section such that upon attachment of the respective locking part at least one fastening compartment is formed in which the front cross tube of the respectively associated structural frame can be received with some play.

7. The system of seat elements according to claim 1, wherein the locking part can be affixed to the seat shell via the at least one fastener means using a screw connection and/or by means of an anchoring,
where, to that end, the locking part is provided with an anchoring element, for example, a hook, which can engage with an undercut groove in the seat shell so as to hold the locking part on the seat shell in a form-fit manner; and/or
where the locking part is provided with a hole through which a screw can be inserted to screw this into an internal thread in the seat shell so as to hold the locking part on the seat shell.

8. The system of seat elements according to claim 1, wherein on the seat shell two fastening members spaced apart from one another in the perpendicular direction are arranged each having at least two fastening channels extending in the perpendicular direction, where the fastening channels of different fastening members are arranged in alignment on the seat shell so that the front cross tube of the respective structural frame can be received in the respectively associated fastening channels of the two different fastening members.

9. A set of seat elements, comprising at least:
a first seat element and a second seat element, each made from the system of seat elements according to claim 1,
the first seat element comprising at least one first structural frame according to a first variant including a front cross tube at a first position and a seat shell held on the first structural frame via a locking part attached to the seat shell,
where the seat shell comprises at least one fastening member which comprises at least two fastening channels extending in the perpendicular direction, where the locking part and a first fastening channel of the at least one fastening member associated with the first structural frame form a first fastening compartment in which the front cross tube of the first structural frame is received, and
the second seat element including at least one second structural frame according to a second variant with a front cross tube at a second position different from the first position, and a seat shell held on the second structural frame via a locking part attached to the seat shell,
where the seat shell comprises at least one fastening member, which comprises at least two fastening channels extending in the perpendicular direction, where the locking part and a second fastening channel of the at least one fastening member associated with the second structural frame form a second fastening compartment in which the front cross tube of the second structural frame is received.

10. The set of seat elements according to claim 9, wherein the seat shell of the first seat element is held on the first structural frame via a first locking part attached to the seat shell, and the seat shell of the second seat element is held on the second structural frame via a second locking part attached to the seat shell,
where the first locking part and the second locking part differ, in particular, both locking parts having different channel-shaped recesses, each forming, together with the associated fastening channel of the fastening member on the seat shell, the respective fastening compartment for receiving the front cross tube of the respectively associated structural frame.

11. The set of seat elements according to claim 9, wherein the seat shells of both seat elements are identical in design.

12. A method for manufacturing a seat element of a vehicle seat, the seat element made of the system of seat elements according to claim 1, including at least the following steps:
determining a variant of the structural frame and, therewith, the seat element to be manufactured (STA);
providing a seat shell with at least one fastening member which comprises at least two fastening channels extending in the perpendicular direction, a structural frame, corresponding to the determined variant, from a number of at least two structural frames which differ in at least one position of a front cross tubes on the respective structural frame, as well as a locking part;
assembling the provided seat shell on the provided structural frame such that the front cross tube of the provided structural frame in a fastening channel of the at least one fastening member associated with the determined variant of the structural frame is received in the provided seat shell;
fixing the front cross tube of the provided structural frame received in the respective fastening channel via the provided locking part in that the provided locking part is attached to the seat shell via at least one fastener means, and the fastening channel on the seat shell which is associated with the determined variant of the structural frame, and the respective locking part form a fastening compartment in which the front cross tube of the provided structural frame is received; and
finishing the seat element in further steps.

13. A method according to claim 12, wherein the locking part is selected from a number of at least two different locking parts depending on the determined variant, where each of the at least two different structural frames is associated with a different locking part.

14. A vehicle seat including a seat element and a backrest, where the seat element is manufactured from a system of seat elements according to claim 1.
